(19) United States
(12) Patent Application Publication
(10) Pub. No.: US 2026/0012682 A1
(43) Pub. Date: Jan. 8, 2026

(54) SYSTEM AND METHOD FOR PROCESSING MULTIMEDIA CONTENT

(71) Applicant: Philip Giffin, Los Angeles, CA (US)

(72) Inventor: Philip Giffin, Los Angeles, CA (US)

(21) Appl. No.: 19/258,199

(22) Filed: Jul. 2, 2025

Related U.S. Application Data
(60) Provisional application No. 63/668,484, filed on Jul. 8, 2024.
(60) Provisional application No. 63/668,496, filed on Jul. 8, 2024.

(51) Int. Cl. H04N 21/44; H04N 21/454; H04N 21/475; H04N 21/488; H04N 21/84

(52) U.S. Cl. CPC H04N 21/44016; H04N 21/454; H04N 21/4756; H04N 21/4884; H04N 21/84

(57) ABSTRACT

A system and method for evaluating multimedia items, enabling instantaneous, real-time, annotation, synchronization, and improved usability. The system eliminates current challenges found in correlating specific moments in multimedia content with location specific, annotations, enhancing workflows for live and recorded events. A processor receives multimedia items, overlays annotations, generates identifiers, and associates them with selected annotations. The annotated content is stored and outputted, facilitating efficient navigation and review. Filtering criteria can be applied to stored annotations, supporting the creation of composite content. Additionally, a speech-to-text algorithm transforms audio waveforms into textual content, aligning text with audio waveforms in precise synchronization. Applications include music production, film and television production, education, sports analysis, and additional entertainment applications. The system integrates user interfaces, tagging modules, and auto-compilation features to streamline annotation and editing processes. This approach improves content evaluation, visualization, and feedback, offering intuitive tools for users to analyze and share annotated content effectively.

### CROSS-REFERENCE TO RELATED APPLICATIONS

This application claims benefit to Provisional Application No. 63/668,484, filed Jul. 8, 2024, and Provisional Application No. 63/668,496, filed Jul. 8, 2024 the contents of which are herein incorporated by reference.

### BACKGROUND OF THE INVENTION

### Field of Endeavor

The present invention relates to multimedia content processing, and more particularly, to systems and methods for processing multimedia content, including evaluation, annotation, visualization, and/or synchronization of multimedia content.

### Background of Related Art

The field of multimedia content processing has expanded significantly in recent years, driven by rapid advancements in digital recording and sensor technologies. Across a wide array of applications-from entertainment and performance analysis to education and sports-there is a growing need on systems that capture, process, and present digital media in a manner that supports detailed evaluation and review. As live events are recorded or as prerecorded content is accessed, users require tools that facilitate a clear understanding of the content's progression and enable subsequent examination with location specific, precision and clarity.

The following invention(s) aim to streamline the experience of capturing and reviewing multimedia events. Users are increasingly in need of interfaces and functionality that allow for the efficient insertion and display of location specific markers, ensuring that significant moments are annotated during live recordings. The objective is to support a more interactive approach, enhancing both real-time engagement and post-capture analysis. These desired features aim to provide the user the option to instantaneously create a time stamped annotation, milliseconds after the occurrence of any event. These annotations, or markers, remain affixed to the audio and/or visual media. Having the ability to instantaneously place markers a millisecond after a phrase, and/or a word, and/or an occurrence of any event, is important because it notates the user's immediate reaction to said events. This spontaneous annotation system also reduces time and effort required in reviewing content after the fact.

Existing digital systems do not provide intuitive mechanisms that allow users to accurately mark specific moments in a continuously evolving event with corresponding annotations. The processes reviewing significant events after the fact is time consuming and interrupts the flow of whatever is being recorded. Additionally, the absence of streamlined integration between capturing any event and the subsequent review of that event, means that important feedback or evaluation markers may become difficult to communicate to one another, leading to inefficient workflows and increased time requirements in evaluating substantial amounts of media.

This system facilitates location specific, synchronized, digital annotations with multimedia content. It uniquely provides instantaneous real-time markers, or timed text displays, which seamlessly handle the dual demands of live event capture and precise, time-correlated, location-specific annotation. Shortcomings without this system can result in delayed feedback, difficulty in revisiting exact moments of interest, and challenges in compiling coherent summaries for subsequent review. These limitations underscore the need for an improved approach that robustly combines content capture and synchronized annotation, thereby streamlining workflows and enhancing user feedback during live or recorded events.

### SUMMARY OF THE INVENTION

In one embodiment, the disclosure includes a computer-implemented method executed by a processor for processing multimedia content items. The method includes receiving multimedia content items and displaying them with overlaid annotations that are selectable by a user. In response to a user's selection of an annotation, an identifier is generated and used to mark the multimedia content item in real time. The identifier is then associated with the selected annotation, and the multimedia content items, the identifier, and the annotation are stored to form stored annotated content items. The method further includes selecting filtering criteria, filtering the stored annotated content items based on these criteria, combining the content items meeting the criteria to form composite content items, and outputting the composite content items. In some embodiments, the identifier is a timestamp, the annotation is a graphical icon, and the graphical icon represents one or more items such as a rating, ranking, feedback, or score. (Referred to later in this document as, Auto-Comp. Also known as, Automatic Compilation.)

In another embodiment, the disclosure includes a computer-implemented method for processing multimedia content items that comprises receiving the multimedia content items and analyzing them using a Speech-To-Text algorithm to form textual content items. The method further comprises aligning the textual content items with the multimedia content items and outputting the textual content items in alignment with the multimedia content items. In certain embodiments, the multimedia content items are audio waveforms, and the aligning further comprises marking each textual content item with an identifier and inserting the textual content items into the multimedia content items at a location indicated by the identifier. (Referred to later in this document as, Navigator.)

In yet another embodiment, the disclosure includes a multimedia content processing system comprising a processing device and a memory device storing computer-readable instructions. When executed by the processing device, these instructions cause the system to receive multimedia content items, display them on a user interface, and receive in real time user input corresponding to a temporal location within the multimedia content items. Based on the user input, timestamped markers are generated, and associated annotations are overlaid on the content items. The system stores the multimedia content items together with the timestamped markers and annotations, and automatically compiles a composite multimedia content item from multiple takes of the content items based on preselected evaluation criteria associated with the annotations. The system further includes a user interface configured to display the multimedia content items and receive user input, as well as a communication interface configured to enable data exchange with external devices.

### BRIEF DESCRIPTION OF THE DRAWINGS

FIG. 1 is a schematic diagram of a system for multi-media content processing, according to aspects of the present invention;

FIG. 2A is a first graphical user interface illustrating aspects of the tagging, and evaluation components of the system for multi-media content processing, according to aspects of the present invention;

FIG. 2B is a second graphical user interface illustrating aspects of the tagging, and evaluation components of the system for multi-media content processing, according to aspects of the present invention;

FIG. 3 is a graphical illustration of the Auto-Comp functionality of the system of multi-media content processing, according to aspects of the present invention;

FIG. 4A is a first graphical illustration of the Navigator functionality of the system of multi-media content processing, according to aspects of the present invention;

FIG. 4B is a second graphical illustration of the Navigator functionality of the system of multi-media content processing, according to aspects of the present invention;

FIG. 5 is a flow diagram of a method of aligning media content performed by the Navigation functionality of the system of multi-media content processing, according to aspects of the present invention; and

FIG. 6 is a flow diagram of a method of evaluating media content according to aspects of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, a first embodiment of the present disclosure provides a digital evaluation and annotation system hereafter referred to as “LIVE-STAMP” allowing the user (e.g., “evaluator”) to annotate specific moments within any live event during the act of viewing said live event. “LIVE STAMP” also allows the evaluator to place annotations on any prerecorded or streamed event, e.g., audio streams, video streams, audio recordings, video recording, other multi-media content and combinations thereof. These digitally placed annotations can be done easily and instantaneously with the touch of a finger or other implement to an input device, e.g., a smart phone screen, and/or digital tablet, and/or laptop, and/or any other computer system. The purpose of these annotations vary depending on the goal of the evaluator. Various examples of the purposes for these annotations may include, but are not limited to: feedback, rating, scoring, commentary, analysis, instructions, questions, and/or notes by an evaluator on any event being watched, live and/or prerecorded. “LIVE STAMP” generates a recording of the event, e.g., a digital media file, in which the annotations are overlayed and superimposed on top of the event being recorded. As many annotations as desired can be easily placed on the event at temporal locations selected by the evaluator.

In embodiments, as the user (e.g., “evaluator”) is experiencing either a live event and/or reviewing recorded media of the event, the evaluator can provide specific input, in real-time, that corresponds to each stamp annotated by the user at any specific time/location throughout the event. The user (e.g., “evaluator”) can touch a screen that places a selection of time-stamped markers at specific locations on the recorded media.

In embodiments, “LIVE STAMP” can include a single electronic device, e.g., smartphone, tablet, etc., for both viewing and recording a live event while annotating time-stamped markers that are superimposed over the event being recorded. For example, “LIVE STAMP” can be used with single electronic device, e.g., smartphone, tablet, etc., or if desired, used with a laptop and/or digital tablet, and/or MIDI controller. Triggered by the evaluator, “LIVE STAMP” generates and displays an overlay of the annotations, and places time-stamped markers at specific moments throughout the event being recorded and displayed on the screen. As the evaluator watches the event, the evaluator selects, in real-time, an annotation that corresponds to a portion of the event being currently viewed and a time-stamped marker is placed in an annotations file. Once viewing the event has ended, “LIVE STAMP” generates an annotated media file in which the annotation is overlayed on the recording of the event at the appropriate time-stamped locations. The annotated media file can then be provided to a user (e.g., “evaluatee”) to view. The user (e.g., “evaluator” and/or “evaluatee”) can be, for example, a participant in the event or the subject of the event.

When recording the human voice in digital audio workstations (DAWs) audio waveforms are always visually represented. For example, the waveform can be represented as a two-dimensional graph which displays audio amplitude changes or level changes over time. Typically, amplitude is measured in a bipolar manner, with positive and negative values. Audio level can be the absolute value or average of amplitude changes.

Currently, whether recording a person singing and/or speaking, the audio engineer, or the operator, hereafter referred to as the “user,” can view that digital waveform. The user, however, has no visual representation of the words which are sung or spoken. The absence of notated words below the corresponding waveform results in time-consuming navigation by the user to locate a desired moment within the performance that corresponds to a word or phrase, such as after, or before, or in the middle of a specific word, etc.

According to a second embodiment of the present disclosure, audio visualization software, hereinafter referred to as “NAVIGATOR”, can generate a visual representation of an audio waveform and a text representation aligned with the audio waveform. Each word that is sung or spoken is automatically notated directly below the digital waveform to which each word corresponds to. “NAVIGATOR” transforms the recorded audio into text using a speech-to-text algorithm and then aligns the text with the audio waveform.

“NAVIGATOR” is compatible with all digital recording platforms and has the ability to notate words in the top 10 most commonly spoken languages. Some examples of digital recording software include, but are not limited to: Pro Tools, Logic, Cubase, Digital Performer, Ableton, FL Studio, PreSonus, Reaper, and more. “NAVIGATOR” puts an end to the trial-and-error process the user currently experiences in order to navigate to any specific location within the waveform. “NAVIGATOR” will greatly benefit all individuals working with digital recordings of the human voice in music, sports, education, film and tv, home use for the novice, plus additional applications not listed here.

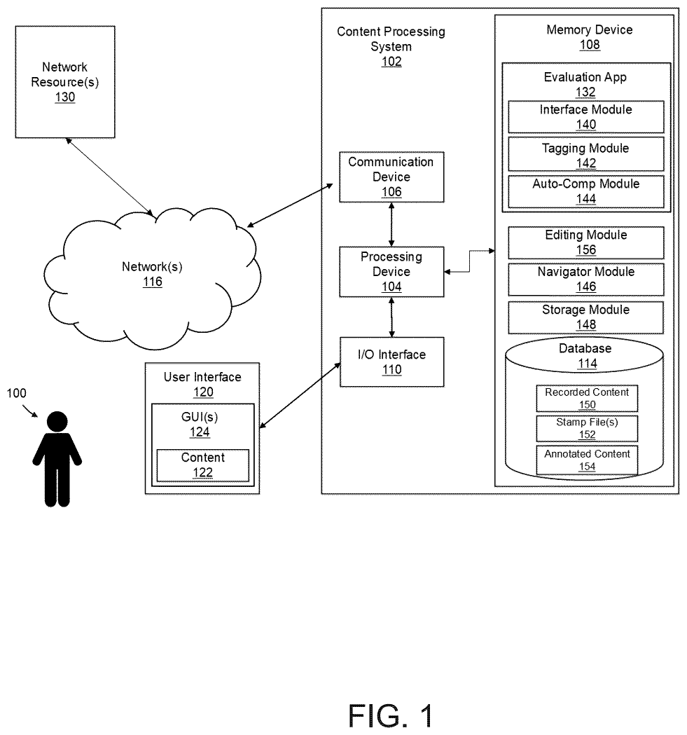

FIG. 1 illustrates a Content processing system (hereinafter “content processing system 102”), according to aspects of the present disclosure. The content processing system 102, in a first embodiment, allows a user 100 to view digital content 122 (hereinafter “content”) and insert markers into a digital file associated with the content 122, which can then be merged with the content 122 to generate annotated media files. The content processing system 102, in a second embodiment, allows a user 100 to view digital content 122 (hereinafter “content”), as a waveform with one or more textual data items inserted below the waveform portion. The waveform is transformed to the one or more textual data items using one or more speech-to-text engines, and each of the one or more textual data items is aligned with the portion of the waveform from which it was created. While FIG. 1 illustrates examples of components of the content processing system 102, additional components can be added and existing components can be removed and/or modified.

As illustrated in FIG. 1, the content processing system 102 includes a processing device 104 coupled to a communication device 106. The processing device 104 is also coupled to a memory device 108, and an input/output (“I/O”) interface 110. In embodiments, the communication interface 104 enables the content processing system 102 to communicate with other devices and systems via one or more networks 116. The content processing system 102 can include one or more electronic devices such as a laptop computer, a desktop computer, a tablet computer, a smartphone, a thin client, and the like.

According to the aspects of the present disclosure, the content processing system 102 can store and execute a copy of an evaluation application 132. The application 132 enables the user 100 operating the user interface 120, to view, mark, and annotate content 122 via a user interface 120. In some embodiments, the evaluation application 122 can be a specifically designed application that operates with the content processing system 102 to perform the processes and methods described herein. While FIG. 1 illustrates the user 100 interacting directly with the content processing system 102, in some embodiments, the user 100 can access the content processing system 102 remotely via the networks 116. For example, the user 100 can utilize a separate user device to communicate with the evaluation system via the networks 116. In some embodiments, the user device can store and execute a specifically designed application and/or a third-party application, such as a web browser, to communicate and interact with the content processing system 102 to perform the processes and methods described herein.

To perform the process described herein, the evaluation application 132 can include an interface module 140, a tagging module 142, and an Auto-Comp module 144 to perform the processes and methods described herein. The interface module 140, the tagging module 142, and the Auto-Comp module 144, can be stored in the memory device 108 can include the necessary logic, instructions, and/or programming to perform the processes and methods described herein. The evaluation application 132, the interface module 140, the tagging module 142, and the Auto-Comp module 144 can be stored in the memory device 108 and can be written in any programming language.

The memory device 108 can also include a database 114 that stores information and data associated with the process and methods described herein. The database 114 can store the content 122 as recorded content 150, stamp files 152 and/or the annotated content 154. The database 114 can be any type of database, for example, a hierarchical database, a network database, an object-oriented database, a relational database, a non-relational database, an operational database, and the like. The storage module 144 operates to store and manage data in the databases 114.

The interface module 140 operates to generate and provide graphical user interfaces (GUIs) 124, for example, menus, widgets, text, images, fields, etc. The GUIs generated by the interface module 140 can be interactive. For example, the GUIs can allow the user 118 of the user interface 120 to interact with the evaluation application 132 to play content 122, insert markers into the content 122, add annotations to the content 122, save the content as annotated files 150, and the like.

The tagging module 142 operates to insert timestamped markers into the content 122, in response to input from the user 100. As the user 100 is experiencing the content 122, either a live event and/or reviewing recorded media, the user 100 can provide input to the user interface 120, which places a selection of timestamped markers at specific locations on the recorded media. That is, the tagging module 142 places, in real-time, a timestamped marker corresponding to the time location in the content 122, when the input was received. After the user 100 has placed the timestamped markers, the user 100 input annotations, via the user interface 120, that are associated with the timestamped markers.

In embodiments, the purpose and utilization of these timestamped markers varies, depending on the goal of the user 100. For example, if the user 100 is witnessing an event as it's occurring in real-time, or if the user 100 is reviewing a recording or a playback of an event, the user 100 can touch the user interface 120, e.g., a screen such as an iPad, other digital tablets, or a smartphone, which will affix timestamped markers on the audio or video recording. In one example, if a user 100 wishes to evaluate or make a note of specific moments within an event, such as a vocalist's, an instrumentalist's performance, or an athlete's performance, these location-specific markers can pinpoint various moments throughout the performance. One of several purposes for these timestamped markers might be to locate and review those specific moments more efficiently or to convey the user's opinion of those moments to someone else.

In embodiments, in music, film, and tv production, it is a standard practice to record multiple takes of any given performance. In one example, content processing system 102, via the auto-comp module 146, can enable the user 100 to keep accurate notes of all the best moments within multiple takes of the same material being recorded. In this scenario, the user has the option to setup the content processing system 102 and define markers, for example, the timestamped markers are numbered from one to five, with five being the highest rating and one being the lowest. Whether it be live, or recorded media, while the performance is taking place, the user 100 has the ability to perform a single action on the user interface 120, e.g., use one hand to tap a digital tablet, or smartphone, for the purpose of evaluating each phrase (or moment) within that performance. Once each phrase (or moments,) within multiple takes of the same material, has been evaluated (one through five), the user 100 can instruct the content processing system 102 to review all of the timestamped markers for the purpose of editing together one single composite take. Out of the multiple takes, the user 100 can instruct the content processing system 102 to create a single, composite take, using only the highest rated moments. The user 100 may also be interested in the content processing system 102 creating a single, composite take, using all of the second to highest moments, and so on.

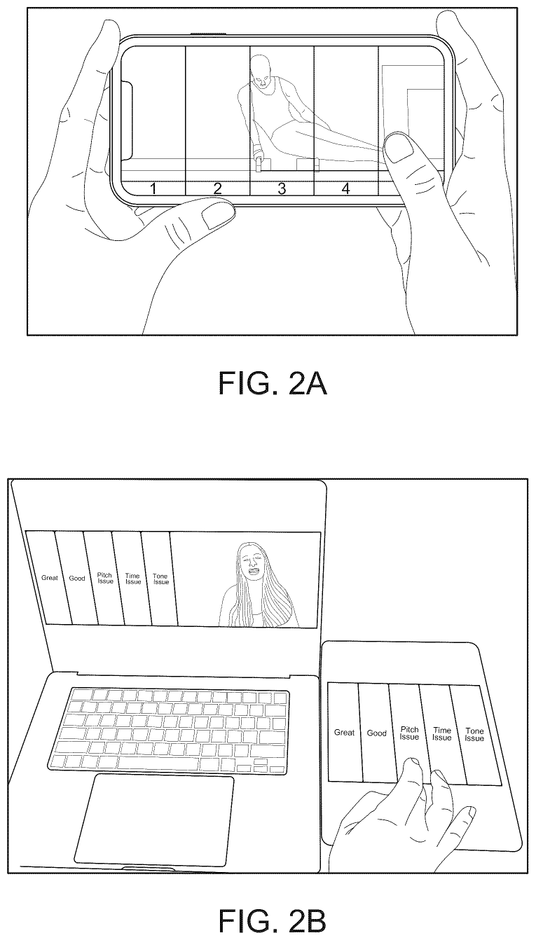

In another example, an individual, or group of individuals, might be seeking feedback regarding their performance of any kind. For the following, we will use an example of a singer seeking feedback from their vocal coach regarding the singer's performance of a song. The singer would ostensibly send their video of themselves to their vocal coach, producer, or anyone else who might be evaluating them. The vocal coach, producer, or anyone else evaluating the singer, e.g., the user 100, can utilize the content processing system 102. As the user 100 listens to the video of the vocal performance, the user 100 interacts with the user interface 120, e.g., touches an electronic tablet (or smartphone), as a means to place a timestamped, color-coded marker beside the singer's video, as illustrated in FIG. 2B. The GUIs 124 can display a predefined and/or customized list of feedback that the user 100 can select while viewing the video.

For example, as discussed above, these timestamped markers appear after a note, or series of notes, or a phrase, which reflect the user's feedback to the singer. In this example, the applicable markers illuminate on the left side of the screen, and convey the following pieces of feedback, as illustrated in FIG. 2B: (Remember these markers illuminate AFTER the note, or series of notes occur.) In embodiments, each timestamped marker is associated with an indicia, such as a color, bolding, or other graphical emphasis. In an exemplary embodiment, as illustrated in FIG. 2B, the phrase that was just such is indicate as GREAT, but placing visual indicia, such as the word GREAT, and/or the color Green. Similarly, a visual indicia such as GOOD, and/or a Blue marker, indicates that the phrase, which was just sung, was GOOD. Furthermore, a visual indicia such as a PITCH ISSUE, and/or a Gold Marker indicates that the phrase, which was just sung, had a PITCH ISSUE. Furthermore, a visual indicia such as TIME ISSUE, and/or a Purple marker indicates that the phrase, which was just sung, had a TIME ISSUE. Finally, a visual indicia such as TONE ISSUE, and/or a Red marker indicates that the phrase, which was just sung, had a TONE ISSUE.

The user 100 can also select a combination of the choices above to reflect the appropriate feedback to the vocalist. With the content processing system 102, the user 100 can quickly and efficiently provide feedback at specific locations within the performance. Unlike any other existing software, whether it's live or recorded media, the moment any event hits the users eye and/or ears, the user has the ability to instantaneously touch a screen which triggers time-stamped markers to be affixed to specific locations of what the user is observing and/or listening to. These unique time and location-specific markers will provide invaluable feedback to the recipient.

The Auto-comp module 144 operates to provide one or more filtering criteria to user 100 for use in creating one or more composite content items from one or more content items, such as annotated content 154. The user can select one or more of the one or more filtering criteria, which can correspond to the timestamped makers inserted, previously, by user 100 into one or more content items. Auto-comp module 144 can provide search functionality to search the one or more content items, such as content items stored in database 114, and return any content items meeting the one or more filtering criteria. In response, to the user 100 selecting one or more content items returned, Auto-comp module 144 can join, or stitch, the selected one or more content items into a single composite content item.

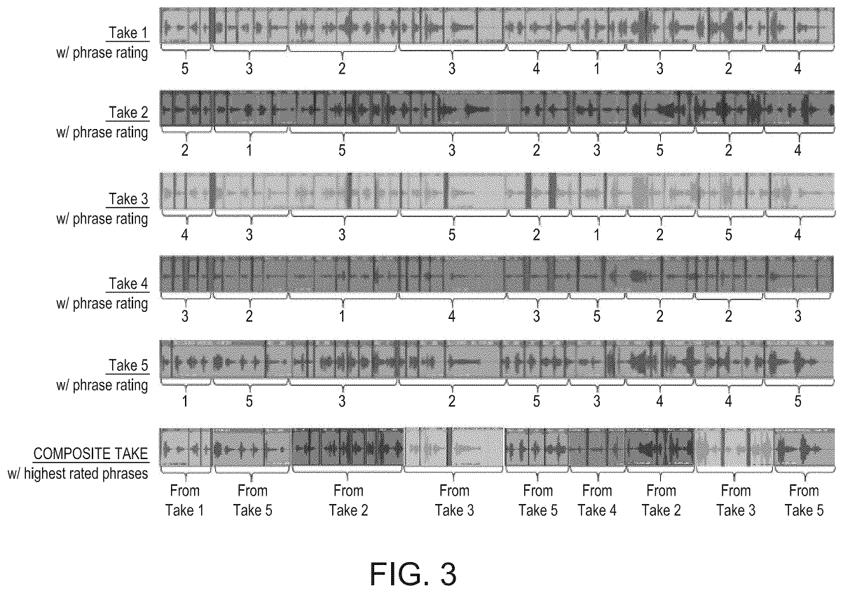

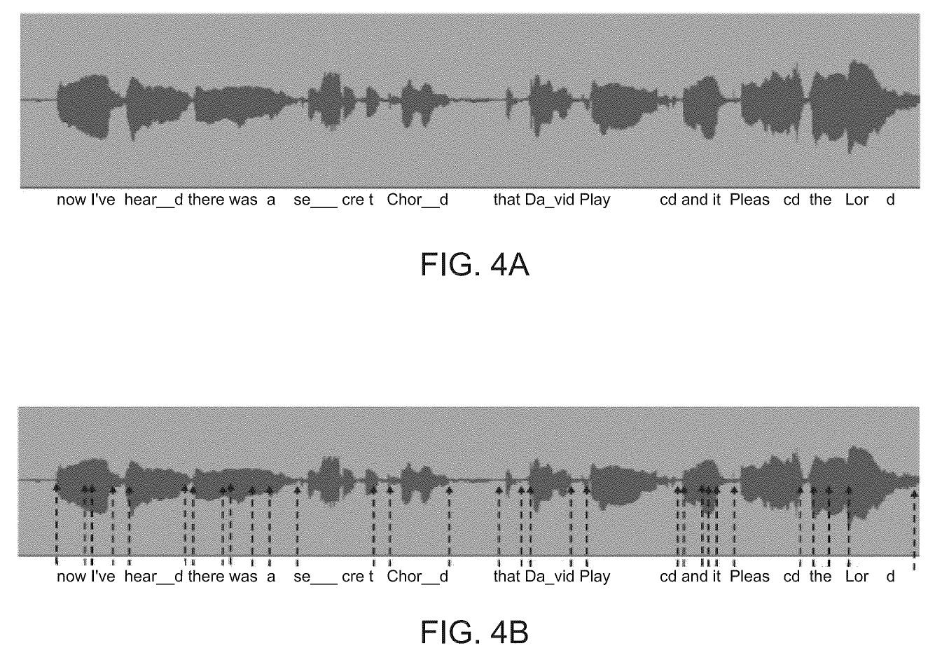

FIG. 3 shows exemplary functionality of Auto-comp module 144, according to aspects of the present invention. In the exemplary embodiment, the user 100 evaluates a plurality of content items, such as Takes 1-5, each of the plurality of content items having one or more timestamp markers 1-5 inserted, in accordance with functionality of tagging module 142. In the exemplary embodiment, the one or more timestamp markers represent a rating scale from 1-5, 1 being the poorest rating to 5 representing the highest rating. The user 100 selects as the one or more filtering criteria the highest rated portion of each of the plurality of content items. In response to the selection the Auto-comp module 144 returns one or more portions of the plurality of content items meeting the one or more filtering criteria, and creates the composite content item, i.e. composite take.

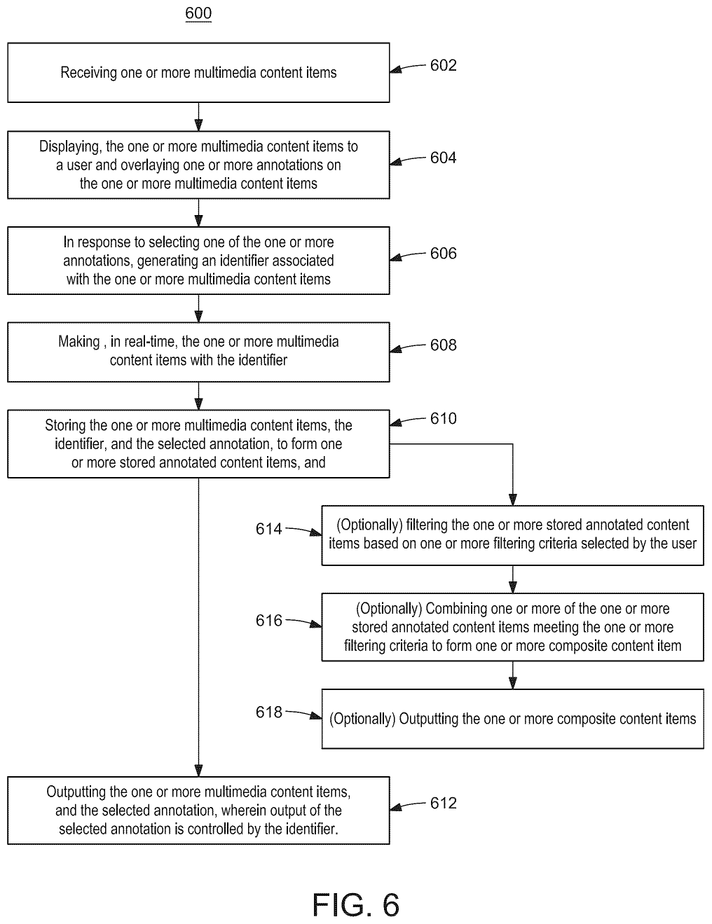

FIG. 6 shows a flowchart illustrating a method of annotating multimedia content, performed by the evaluator app 132. The method comprises sequential steps that enable the user to annotate, store, and optionally filter and combine multimedia content items for enhanced usability and analysis.

The process begins at step 602, where one or more multimedia content items are received. These multimedia content items can include audio files, video files, or other forms of digital media. The evaluator app 132 is configured to process these content items, preparing them for subsequent annotation and manipulation.

At step 604, the received multimedia content items are displayed to the user. During this step, the evaluator app 132 overlays one or more annotations on the multimedia content items. These annotations can include graphical icons, text, or other markers that are superimposed on the content to provide context or feedback.

Step 606 involves generating an identifier associated with the multimedia content items in response to the user selecting one of the annotations. The identifier, such as a timestamp, serves as a distinct marker that correlates the annotation with a specific moment or location within the multimedia content.

At step 608, the multimedia content items are marked in real-time with the identifier. This ensures that the annotations are precisely synchronized with the corresponding moments in the content, enabling accurate and efficient navigation during subsequent review.

Step 610 stores the multimedia content items, the identifier, and the selected annotation to form one or more stored annotated content items. These stored items are saved in a database 114 or memory device 108, allowing the user to access and manipulate them later.

At step 612, the annotated multimedia content items are outputted along with the selected annotations. The output of the annotations is controlled by the identifier, ensuring that the annotations are displayed at the correct temporal locations within the content.

The method also includes optional steps for further processing of the annotated content. At step 614, the stored annotated content items can be filtered based on one or more filtering criteria selected by the user. This allows the user to isolate specific annotations or moments within the content that meet predefined conditions.

Step 616 enables the user to combine one or more of the filtered annotated content items to form composite content items. This step is particularly useful for creating a single, cohesive representation of the most noteworthy or relevant moments from multiple annotated content items.

At step 618, the composite content items are outputted. This step provides the user with a streamlined and consolidated version of the multimedia content, incorporating the selected annotations and filtered criteria.

The flowchart in FIG. 6 highlights the technical capabilities of the evaluator app 132 in transforming multimedia content into annotated and optionally filtered or combined formats. This process enhances the user's ability to analyze, review, and share multimedia content efficiently.

According to a second aspect of the present disclosure, the content processing system 102 can store and execute a copy of editing module 156. The editing module 156 can allow a user 118 to capture, store, and edit audio and/or video data via a user interface 120. The computer system 102 can also store and execute a copy “NAVIGATOR” module 142. “NAVIGATOR” module 142 can include the necessary logic, instructions, and/or programming to perform the processes and methods described herein. “NAVIGATOR” module 142 can be written in any programming language. “NAVIGATOR” module 142 can be standalone application and/or a plug-in compatible with the editing software 140.

“NAVIGATOR” module 142 can generate a visual representation of an audio waveform and a text representation aligned with the audio waveform, as illustrated in FIG. A. “NAVIGATOR” module 142 automatically notates each word that is sung and/or spoken directly below the digital waveform to which each word corresponds to. “NAVIGATOR” module 142 transforms the recorded audio into text using a speech-to-text algorithm and then aligns the text with the audio waveform, as illustrated in FIG. B. In embodiments, the audio data can be an audio track or file and/or a video track or file including audio.

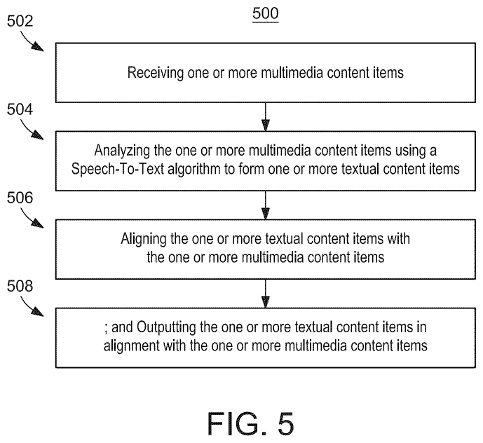

FIG. 5 shows a flowchart illustrating the method of providing textual content in alignment with an audio waveform, as performed by “NAVIGATOR” Module 146. The method comprises four sequential steps, each contributing to the transformation and alignment of multimedia content with corresponding textual data.

In the first step, 502, the method begins by receiving one or more multimedia content items. These multimedia content items can include audio files, video files containing audio, or other forms of digital media. “NAVIGATOR” Module 146 is configured to process these content items, preparing them for subsequent analysis and transformation.

The second step, 504, involves analyzing the received multimedia content items using a Speech-To-Text algorithm. This algorithm processes the audio components of the multimedia content to generate one or more textual content items. The Speech-To-Text algorithm is capable of transcribing spoken or sung words into text, ensuring that each word corresponds accurately to the audio data from which the text was derived. This step plays a significant role in facilitating the alignment of textual data with the audio waveform.

In the third step, 506, the method aligns the textual content items with the multimedia content items. “NAVIGATOR” Module 146 ensures that each word or phrase in the textual content is precisely synchronized with the corresponding portion of the audio waveform. This alignment process involves marking each textual content item with an identifier, such as a timestamp, and inserting the textual content at the appropriate location within the multimedia content. The result is a seamless integration of text and audio data, allowing users to visually correlate the waveform with the transcribed text.

The final step, 508, outputs the aligned textual content items alongside the multimedia content items. “NAVIGATOR” Module 146 generates a visual representation in which the text is displayed directly below the corresponding audio waveform. This output format provides users with an intuitive and efficient way to navigate and analyze audio data, eliminating the need for trial-and-error navigation to locate specific moments within the waveform.

The method illustrated in FIG. 5 highlights the technical capabilities of “NAVIGATOR” Module 146 in transforming multimedia content into a synchronized and visually accessible format. This process is particularly beneficial for applications in digital audio workstations, music production, education, and other fields requiring precise alignment of audio and textual data.

Returning to FIG. 1, the processing device 104, the communication device 106, the memory device 108, and the I/O interface 110 can be interconnected via a system bus. The system bus can be and/or include a control bus, a data bus, an address bus, and the like. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device. While FIG. 1 illustrates a single processing device 104, the content processing system 102 can include multiple processing devices 104, whether the same type or different types.

The memory device 108 can be and/or include one or more computerized storage media capable of storing electronic data temporarily, semi-permanently, or permanently. The memory device 108 can be or include a computer processing unit register, a cache memory, a magnetic disk, an optical disk, a solid-state drive, and the like. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device 108. While FIG. 1 illustrates a single memory device 108, the content processing system 102 can include multiple memory devices 108, whether the same type or different types.

The communication device 104 enables the content processing system 102 to communicate with other devices and systems. The communication device 104 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. programming installed on a processor, such as the processing component, coupled to the antenna.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The content processing system 102 can communicate with one or more network resources via the networks 116. The one or more network resources can include external databases, social media platforms, search engines, file servers, web servers, or any type of computerized resource that can communicate with the content processing system 102 via the network 116.

In embodiments, the components and functionality of the content processing system 102 can be hosted and/or instantiated on a “cloud” and/or “cloud service.” As used herein, a “cloud” and/or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the content processing system 102 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

The user interface 120 of the content processing system 102 can include any user interface for outputting information in a format perceptible by a user and receiving input from the user. For example, the content processing system 102 can communicate with the user interface 120 via the I/O interface 112. The user interface 120 can display GUIs 124 generated by the content processing system 102. The user interface can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A computer-implemented method, executed by a processor, of processing one or more multimedia content items, comprising:
receiving, by the processor, the one or more multimedia content items;
displaying, the one or more multimedia content items to a user and overlaying one or more annotations on the one or more multimedia content items, wherein the one or more annotations are selectable by the user;
in response to selecting one of the one or more annotations, generating an identifier associated with the one or more multimedia content items;
marking, in real-time by the processor, the one or more multimedia content items with the identifier;
associating, by the processor, the identifier with the selected annotation;
storing, by the processor, the one or more multimedia content items, the identifier, and the selected annotation, to form one or more stored annotated content items;
selecting, by the user, one or more filtering criteria;
filtering, by the processor, the one or more stored annotated content items based on the one or more filtering criteria;
combining, by the processor, one or more of the one or more stored annotated content items meeting the one or more filtering criteria to form one or more composite content items; and
outputting, by the processor, the one or more composite content items.

2. The computer-implemented method of claim 1, wherein the identifier is a timestamp.

3. The computer-implemented method of claim 1, wherein the annotation is a graphical icon.

4. The computer-implemented method of claim 1, wherein the graphical icon represents one or more of: a rating, a ranking, a feedback, or a score.

5. A computer-implemented method, executed by a processor, for processing one or more multimedia content items, comprising:
receiving, by the processor, the one or more multimedia content items;
analyzing, by the processor, the one or more multimedia content items using a Speech-To-Text algorithm to form one or more textual content items;
aligning, by the processor, the one or more textual content items with the one or more multimedia content items; and
outputting the one or more textual content items in alignment with the one or more multimedia content items.

6. The method of claim 5, wherein the one or more multimedia content items are one or more audio waveforms.

7. The method of claim 5, wherein the aligning further comprises:
marking each of the one or more textual content items in the one or more multimedia content items with an identifier; and
inserting each of the one or more textual content items in the one or more multimedia content items at a location indicated by the identifier.

8. A multimedia content processing system, comprising:
a processing device; a memory device in communication with the processing device and storing computer-readable instructions which, when executed by the processing device, cause the system to:
receive one or more multimedia content items;
display the one or more multimedia content items on a user interface;
receive, in real time, user input corresponding to a temporal location within the one or more multimedia content items;
generate timestamped markers based on the user input;
overlay on or more annotations associated with the timestamped markers on the one or more multimedia content items;
store the one or more multimedia content items together with the timestamped markers and annotations; and
automatically compile a composite multimedia content item from multiple takes of the one or more multimedia content items based on preselected evaluation criteria associated with the annotations;
a user interface coupled with the processing device and configured to:
display the one or more multimedia content items; and
receive the user input; and
a communication interface operatively coupled to the processing device and configured to enable data exchange between the system and one or more external devices.
